(19) United States
(12) Patent Application Publication
(10) Pub. No.: US 2005/0214730 A1
(43) Pub. Date: Sep. 29, 2005

(54) Method of and apparatus for supplementing the reading of selected passages of printed material in a book or the like by electronically reading coded indicia provided in the book at such passages to access the playing of corresponding coded tracks of pre-recorded video/audio supplemental material respectively related to the selected passages

(76) Inventor: Robert H. Rines, Concord, NH (US)

Correspondence Address: RINES & RINES, 81 N. STATE STREET, CONCORD, NH, 03301, US

(21) Appl. No.: 10/807,894

(22) Filed: Mar. 24, 2004

(51) Int. Cl. G09B 5/00; G09B 17/00

(52) U.S. Cl. 434/318

(57) ABSTRACT

A technique and apparatus for supplementing different subject-matter book passages at the option of the reader with external visual/audio supplementary material on the corresponding respective different subject matters through coded indicia provided at said passages and readable by an electronic reader controlling a storage-medium visual/audio player wand for accessing the playing of such corresponding supplementary visual/audio material from corresponding coded tracks of the medium corresponding to the code indicia in the book.

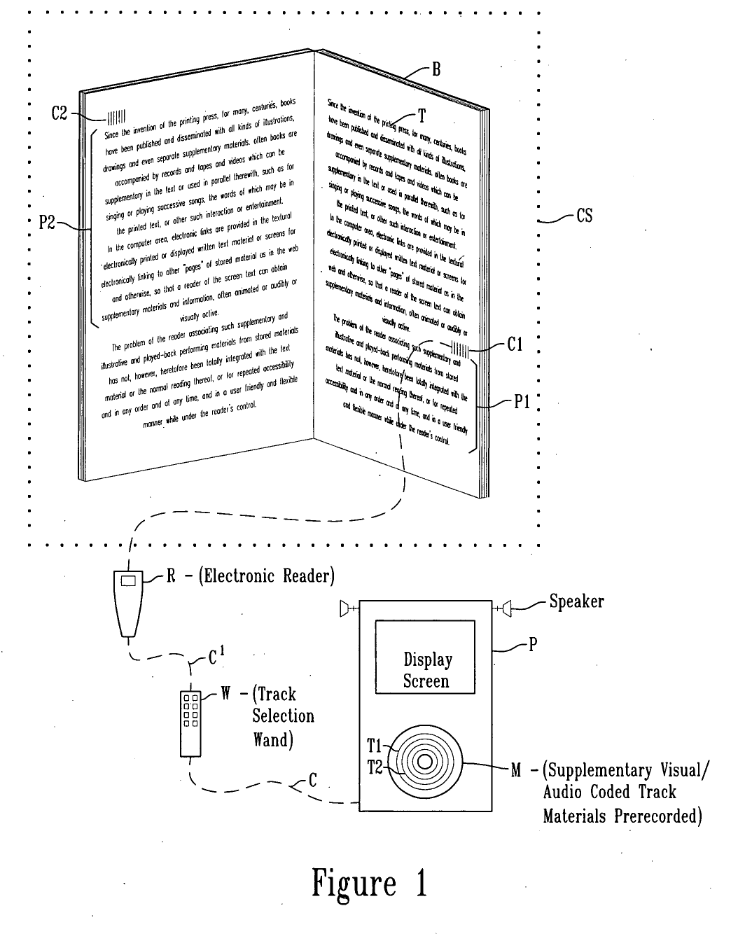

The present invention relates to supplementing the written or printed descriptions read by a reader of books and the like, with video screen presentations and illustrations and related displays of supplemental materials that may be viewed by the book reader and that specifically relate to and supplement the specific subject matter of the respective written descriptions or passages on a page or pages—all at the option and will of the reader. The invention is particularly directed to bringing the written words “alive” through enabling contemporaneous viewing of pre-assembled and stored illustrations with or without sound description, such as video, motion picture or other illustrative or documentary materials and the like, that can provide a “live” video/audio played-back supplement to the content of the specific passages read by the reader for enriching the reading process. That reading process can then continue after the relevant supplementary material has been accessed and viewed as on a CD or DVD player or the like.

### BACKGROUND

Since the invention of the printing press, for many centuries, books have been published and disseminated with all kinds of illustrations, drawings and even separate supplementary materials. Often books are accompanied by records and tapes and videos which can be supplementary to the material in the text or used in parallel therewith, such as for singing or playing successive songs, the words of which may be in the printed text, or other such interaction or entertainment.

In the computer area, electronic links are provided in the textual electronically printed or displayed written text material or screens for electronically linking to other “pages” of stored material as in the web and otherwise, so that a reader of the screen text can obtain supplementary materials and information, often animated or audibly or visually active.

The problem of the reader associating such supplementary and illustrative and played-back performing materials from stored materials has not, however, heretofore been totally integrated with the text material or the normal reading thereof, or for repeated accessibility and in any order and at any time, and in a user-friendly and flexible manner—all under the reader's control.

It is to these considerations that the present invention, accordingly, is primarily directed; it being conceived that the reader of a book or other textual material may wish to readily to access, re-access (and in any order), and view supplemental related subject matter illustrations, photographs, audio and visual supplementary information expanding upon the read passages after or while reading such particular passages of the text. If the reader desires to exercise such an option, the invention enables the reader right then and there, and with immediate association with the textual material that has been read and as which the reader would like further supplementary related subject-matter visual and audio materials, to depart from the reading of the book and automatically view relevant recorded analog or preferably digital tracks of a CD or DVD or other similar medium that builds upon the written textual passage or portion of the book that has just been read—and to do so at any time and in any accessing order.

This enables much more material to be available than the practical preparation of a book and its printing can accommodate, and, in addition, provides a very inexpensive and potentially large library of such supplementary illustrative materials which just cannot be published in any one book or even collection of books, economically or physically. In preparing a book or a text, furthermore, copious editing is required which is time-consuming and expensive and invariably results in required omissions of materials dictated by the limitations of the production and commercial nature of the book or other publication. The use of DVD, CD or other storage memories, however, is ideal for massive track-coded storage of accumulated supplemental data—photo albums, illustrations, videos, movies, documents, audio and other visual material storage—even in unedited form—which are still extremely interesting to the reader who elects to supplement the reading of specific subject-matter written passages of the text with contemporaneous viewing and hearing of such a collection of subject-matter-related memorabilia and illustrations. The “live” access to the contemporaneous reproducing of such pre-recorded supplemental materials provides an enjoyable addition and informational supplement to the specific material read in the book passage. This then provides an inexpensive and instantly subject-matter accessible coded “album” available to the book purchaser which is not currently available when books are published and distributed for reading.

The invention, furthermore, provides for a very user-friendly and compact supplementary means for the reader to continue in the mode of centuries in picking up a book and reading anywhere at all—but being provided with access to such relevant supplementary stored materials simply by visual code, link or similar representations or indicia printed in the margin of the book in association with the text passages describing a particular subject matter or events, and which indicia the reader can instantly electronically scan and automatically access coded recorded tracks, corresponding to the respective coded indicia, of the conventional CD, DVD player or similar media player which the book reader invariably has accessible in the home or other location.

While this invention is particularly useful for the commercial book and related publishing business, the invention is also useful for the family and the amateur wishing to organize all of the photographs, videos, movies and other materials of meaning to the family as a diary or other record of family events for reliving recollections of family history and events. Again, for the use of CD, DVD or other similar coded-track storage of all of the familial photographs and videos, memorabilia and so forth, editing and even chronology are not required. The coded indicia placed in the margin of the books, diary or other records will be keyed to particular correspondingly coded tracks or areas of the recorded supplementary CD, DVD or other material, which greatly simplifies and obviates the need for indexing and the time and effort involved in the preparation of the same.

While reference has been made herein to “books” or computer or other electronic “screens”, diaries or other physically printed or written or electronically printed and displayed text materials and the like, all such shall be understood to be generically sometimes referred to herein as simply “books” and embraced within that term; similarly, the electronic media for storing and then replaying the relevant stored supplementary material, photographs, documents, audio - video tapes, movies etc. are also hereinafter sometimes generically referred to as supplementary pre-recorded or stored visual or video/audio materials and the like.

### OBJECTS OF INVENTION

It is therefore a primary object of the present invention to expand the access to information and supplementary information that a reader of the book may be interested in pursuing upon reading a particular portion or passage of the book and contemporaneously desiring to view and hear supplementary material specifically related to or expanding upon the specific subject matter of the read portion or passage; the invention providing a novel method of and apparatus for expanding the reading enjoyment and education of the book reader in a user-friendly manner and without departing from the centuries old format of a book (or the format of electronic printed materials and computer and other screen displays).

A further object is to provide such a novel method that simplifies the necessity for indexing of supplementary materials or the chronological ordering of such in supplemental media and the like for use with the book through the use of appropriate code indicia actually printed or impressed or otherwise marked on the margin or free space of the book in apposition to or near the specific passage(s) text material, the specific subject matter of which, the reader opts to seek visual/audio supplementation, and in any order and with infinite repetition or timing to increase enjoyment and understanding.

Still an additional object is to provide a new and improved “book” or the like that inherently links to external supplemental pre-recorded materials that the publication of the book did not physically or economically permit to be included therein.

Other and further objects will be explained hereinafter and will be pointed out particularly in connection with the appended claims.

### SUMMARY

In summary, however, from one of its important aspects, the invention embraces in one of its most general formats, a method of supplementing the materials of various passages of different printed book descriptive materials during a reader's reading of the same, with visual supplemental materials, optionally with audio, correspondingly specifically related to and/or expanding upon the specific subject matter of the various passages of printed descriptive materials, that comprises, electronically storing on tracks of a recorded storage medium, pluralities of such visual supplemental information, each so related specifically to the subject matter of a different corresponding passage of the printed descriptive material in the book, and provided with accessing coding specific to each such track of the medium; printing or otherwise applying and displaying on the pages of the book alongside each of the various descriptive material passages, an electronically readable code indicia corresponding specifically to that coded track of the medium containing the recorded specific visual/audio supplemental material related to the corresponding specific printed descriptive material passage; providing an electronic wand for remotely selectively accessing the respective tracks of a medium player available to the book reader, and controlling the visual/audio playing of the same for displaying/reproducing to the reader said supplemental visual information recorded on the respective tracks; and further providing to the book reader an electronic reader of said coded indicia, adapted to actuate the electronic wand to play back respective coded tracks of the medium in the player in accordance with the book reader applying the electronic indicia reader to the respective code indicia in the book, thereby to enable the book reader, contemporaneously with reading, to watch/listen to the played-back visual/audio supplemental material and while, if desired, continuing the facility for simultaneously re-reading the corresponding printed passage in the book during, before or after such playback.

Preferred and best mode designs and implementations of the invention are later fully detailed.

### DRAWING

The invention will now be described in connection with the accompanying drawing which provides a schematic diagram of a preferred implementation of the invention.

### DESCRIPTION OF PREFERRED EMBODIMENTS

Referring to the drawing, conventional facing pages of a printed book B are shown having textual written or printed portions T that a reader may read in the conventional use of the book. Should the reader desire to see pictures or other visual materials, videos or movies, or to hear audio tapes or records, or to see supplementary documents or the like that specifically relate to or supplement specific subject-matter passages or portions of this textual portion T, such as the upper left-hand passages P2 or the lower right-hand passages P1, for example, of specific different respective subject matter, the invention provides for respective coded indicia or markers, C2, C1, etc. in the margins of the book adjacent or near the respective subject matter T passages P2, P1, etc. These coded indicia may be printed in barcode or other coded format link which is keyed to respective coded tracks T2, T1, etc. of a CD, DVD or the like containing corresponding respective subject-matter supplemented material pre-recorded on a storage medium M, such as on a CD disc or DVD or the like.

The disc or other track-coded storage medium is shown within a player P accessible to the book reader and with conventional visual (video)/audio or (sound) reproducing and display screens, including, computer and television interfacing. The operation actuation of the medium track is effected from a wand W controlling the accessing and live playing back of the respective tracks T1, T2, etc. of the storage medium M by wired, remote or wireless communication, schematically represented at C, as is well known. Suitable wand types for example, may be the Radio Shack (2004) remote models 15-2116, 15-2129 and 15-2138 among others.

The control of the wand W to playback the respective tracks of the medium M containing respective pre-recorded supplemental material related to or expanding upon the specific corresponding respective subject matters of the passages P1, P2, etc. is, in turn, controlled by an electronic code indicia reader R provided to the book reader and which activates the wand W, again by wired, remote or wireless communication, schematically indicated at C¹.

Thus, once the book reader has read the particular subject matter of, say, passage P1 and desires to view/hear supplemental material as to that specific subject matter—for example, pictures or a video clip with sound—the book reader thereupon scans with the hand-held reader R the code indicia C1 (bar code unique symbol or the like) printed or otherwise affixed in the margin near the passage P1 and thereby activates the wand W to select and trigger the playback on the player P of the corresponding visual/audio supplemental material as to that specific matter described in passage P1 that has been pre-recorded on the corresponding track T1 of the medium M. Similarly, the book reader, having earlier read about different subject matter in written passage P2, may wish to view/hear supplemental material as to that subject matter that has been pre-recorded on corresponding coded track T2 of the medium M. This is effected by the reader scanning the electronic reader R over the coded indicia P2 that will cause the wand W to access the corresponding coded track T2 of the medium M on which has been stored the corresponding supplemental material relating to or expanding upon the specific subject matter of the passage P2.

The book reader, moreover may repeatedly access such supplemental material, and may access at any time and in any order whatsoever, as desired.

The invention, in summary, thus provides a cooperative method and apparatus for supplementing the materials of various passages of different printed book descriptive materials P1, P2, etc. during a reader's reading of the same, with visual supplemental materials and optionally with audio, correspondingly specifically related to and/or expanding upon the specific different subject matters of the various different passages P1, P2, etc. of the printed (written) descriptive materials T. As previously described, the electronic prerecording in the storage medium M, of corresponding pluralities of such visual supplemental information, each related specifically to the subject matter of a different corresponding passage P1, P2, etc. of the printed descriptive material T in the book B, is stored along correspondingly recorded tracks of the recorded storage medium M—with coding-specific conventional wand-accessing to each such corresponding track T1, T2, etc. of the medium M. On the pages of the book alongside each of the various descriptive material passages P1, P2, etc., as earlier explained, there has been printed or applied or displayed electronically readable code indicia C1, C2, etc. corresponding specifically and respectively to the coded tracks T1, T2, etc. of the medium M containing the recorded specific visual supplemental material related to the corresponding specific printed descriptive material passage. The electronic wand W thus remotely selectively accesses the tracks T1, T2, etc. of the playback displayer P and controls the visual/audio playing of the same for reproducing and displaying to the book reader the appropriate related supplemental visual information upon the playback displayer. The book reader, with the hand-held electronic reader R, simply scans the desired coded indicia C1, C2, etc., thereby controlling the wand W to actuate the corresponding playback tracks T1, T2, etc. of the medium M in the player P and thereby enable the book reader to watch “live” and listen to the appropriate played-back visual supplemental material. If desired, moreover, the reader may maintain the continued facility for simultaneously re-reading of the corresponding printed passages P1, P2, etc. during, before, or after such playback—all at the option of and under the control of the book reader.

In practical implementations, the electronic reader R may be a portable hand-held miniaturized element as shown, communicating with (commanding) the wand W, with the wand in any of wired, remote or wireless communication with the player P as is widely done today. If desired, the electronic reader R and wand W may be integrally packaged as a single hand-held longitudinal tool, storable with the book B or connected by a cord thereto (not shown) or detachably held.

As before explained, the underlying concept of the invention is not, however, restricted to the format of a conventional book, as shown for illustrative purposes—printed, handwritten or having other impressed text. A computer or other television or monitor screen format on which the text is electronically printed or displayed, schematically indicated in dotted lines as CS, is also a possible “book” format for which the invention is most useful, and wherein, the electronic indicia reader R may conveniently assume the form of a “mouse”—like overlay or the user's finger or an implement for touch-screen activation of the coded indicia. In such a use, the player P maybe incorporated in the computer or monitor system.

Further modifications will also occur to those skilled in this art and such are considered to fall within the spirit and scope of the invention as defined in the appended claims.

1. A method of supplementing the materials of various passages of different printed book descriptive materials during a reader's reading of the same, with visual supplemental materials, and optionally with audio, correspondingly specifically related to and/or expanding upon the specific subject matter of the various passages of printed descriptive materials, that comprises, electronically storing on tracks of a recorded storage medium pluralities of such visual supplemental information, each so related specifically to the subject matter of different corresponding passages of the printed descriptive material in the book, and provided with accessing coding specific to each such track of the medium; printing or otherwise applying and displaying on the pages of the book alongside each of the various descriptive material passages, an electronically readable code indicia corresponding specifically to that coded track of the medium containing the recorded specific visual/audio supplemental material related to the corresponding specific printed descriptive material passage; providing an electronic wand for remotely selectively accessing the respective tracks of a medium player available to the book reader, and controlling the visual/audio playing of the same for displaying/reproducing to the reader said supplemental visual information recorded on the respective tracks; and further providing to the book reader an electronic reader of said coded indicia, adapted to actuate the electronic wand to playback respective coded tracks of the medium in the player in accordance with the book reader applying the electronic indicia reader to the respective code indicia in the book, thereby to enable the book reader, contemporaneously with reading, to watch/listen to the played-back visual/audio supplemental material and while, if desired, continuing the facility for simultaneously re-reading the corresponding printed passage in the book during, before or after such playback.

2. The method of claim 1 wherein the electronically readable code indicia are applied in the book to the unprinted margins or spaces of the book pages near the corresponding printed passages.

3. The method of claim 1 wherein the book reader's application of the electronic code indicia reader to a selected book coded indicia, automatically also actuates the wand in turn to actuate the player to select and play the respective recorded track on the medium corresponding to the book reader's selected book indicia.

4. The method of claim 1 wherein the electronic reader is a portable hand-held miniaturized element in wired, remote or wireless communication with the wand, and the wand is in wired, remote or wireless communication with the player.

5. The method of claim 1 wherein the electronic reader and wand are integrally packaged.

6. The method of claim 1 wherein at least the electronic reader is provided with the book.

7. The method of claim 1 wherein the coded indicia comprise barcodes.

8. A method of supplementing the material of various passages on pages of descriptive written materials with corresponding visual and/or audio supplemental materials specifically and respectively related to and/or expanding upon the subject matter of said passages, that comprises, recording for playback on a player such supplemental materials and in respective subject-matter coded tracks; placing on the pages, coded indicia corresponding to said coded tracks of the supplemental recorded materials and near the regions of the respective corresponding subject-matter written passages; and electronically reading the indicia at the selected passages, automatically to actuate the playback of the player of the supplemental recorded material tracks corresponding to the respective selected written passages.

9. Apparatus for supplementing the materials of various passages of different printed book descriptive materials during a reader's reading of the same, with visual supplemental materials, optionally with audio, correspondingly specifically related to and/or expanding upon the specific subject matter of the various passages of printed descriptive materials, having, in combination, an electronically recorded storage medium storing tracks of pluralities of such visual supplemental information, each so related specifically to the subject matter of a different corresponding passage of the printed descriptive material in the book, and provided with accessing coding specific to each such track of the medium; electronically readable code indicia printed or otherwise applied and displayed on the pages of the book alongside each of the various descriptive material passages, the indicia corresponding specifically to that coded track of the medium containing the recorded specific visual/audio supplemental material related to the corresponding specific printed descriptive material passage; an electronic wand for remotely selectively accessing the respective tracks of a medium player available to the book reader, and for controlling the visual/audio playing of the same for displaying/reproducing to the reader said supplemental visual information recorded on the respective tracks; and an electronic reader of said coded indicia, adapted for the reader to actuate the electronic wand to play back respective coded tracks of the medium in the player in accordance with the book reader applying the electronic indicia reader to the respective code indicia in the book, thereby to enable the book reader, contemporaneously with reading, to watch/listen to the played-back visual/audio supplemental material and while, if desired, continuing the facility for simultaneously re-reading the corresponding printed passage in the book during, before or after such playback.

10. The apparatus of claim 9 wherein the electronically readable code indicia are applied in the book to the unprinted margins or spaces of the book pages near the corresponding related printed passages.

11. The apparatus of claim 9 wherein means is provided for the book reader's application of the electronic code indicia reader to a selected book coded indicia, automatically also to actuate the wand in turn to actuate the player to select and play the respective recorded track on the medium corresponding to the book reader's selected book indicia.

12. The apparatus of claim 9 wherein the electronic reader is a portable hand-held miniaturized element in wired, remote or wireless communication with the wand, and the wand is in wired, remote or wireless communication with the player.

13. The apparatus of claim 9 wherein the electronic reader and wand are integrally packaged.

14. The apparatus of claim 9 wherein at least the electronic reader is provided with the book.

15. The apparatus of claim 9 wherein the coded indicia comprise barcode.

16. The apparatus of claim 12 wherein either the reader alone or the reader and wand are packaged in the form of a hand-held tool.

17. The apparatus of claim 16 wherein the hand-held package is of longitudinal shape storable with the book.

18. The apparatus of claim 17 wherein the hand-held package is connected by a cord to the book.

19. The apparatus of claim 17 wherein the tool is detachably connectable to the book.

20. Apparatus for supplementing the material of various passages on pages of descriptive written materials with corresponding visual and/or audio supplemental materials specifically and respectively related to and/or expanding upon the subject matter of said passages, that comprises, a recorded storage medium for playback on a player of such supplemental materials recorded in respective subject-matter coded tracks; coded indicia corresponding to said coded tracks of the supplemental recorded materials placed on the pages near the regions of the respective corresponding subject-matter written passages; and an electronic reader for reading the coded indicia at the selected passages, automatically to effect actuation of the playback of the player of the supplemental recorded material tracks corresponding to the respective selected written passages.

21. A method of supplementing the material of various passages on pages of descriptive written materials with corresponding visual and/or audio supplemental materials specifically and respectively related to and/or expanding upon the subject matter of said passages, that comprises, recording for playback on a player such supplemental materials and in respective subject-matter coded tracks; placing on the pages, coded indicia corresponding to said coded tracks of the supplemental recorded materials and near the regions of the respective corresponding subject-matter written passages; and enabling a reader of the written materials to communicate selected indicia to the player, automatically to actuate the playback of the player of the supplemental recorded material tracks corresponding to the respective selected written passages.

22. The method of claim 21 wherein the reader communication to the player of reader-selected indicia is effected by the reader initiating electronic reading of the indicia and communication thereof to the player.

23. The method of claim 21 wherein the player is remote from the reader and the communication is wireless.

24. A method of supplementing the material of various passages on pages of descriptive written materials with corresponding visual, pictorial, or video supplemental materials specifically and respectively related to and/or expanding upon the subject matter of respective of said passages, that comprises, electronically storing in a storage medium of a playback system such supplemental materials and in corresponding respective subject-matter coded tracks; placing on the pages, coded indicia corresponding to said coded tracks of the supplemental materials stored in the storage medium, and near the regions of the respective corresponding relevant subject-matter written passages; and enabling a reader to select written materials and to communicate the corresponding selected indicia to the storage medium playback system, automatically to actuate said system to play back from the storage medium for viewing on the playback system by the reader, the supplemental stored material of the respective tracks corresponding to the respective selected written passages.

25. The method of claim 24 wherein the reader communication to the storage medium playback system of reader-selected indicia is effected by the reader initiating reading of the indicia at said written passages, and communication thereof to the storage medium playback system.

26. The method of claim 25 wherein said indicia reading is effected by electronic scanning by the written material reader.

27. The method of claim 24 wherein the storage medium playback system is remote from but visible to the reader of the written material, and the communication thereto is wireless.

28. The method of claim 24 wherein the storage medium playback system comprises a CD, CD player and display screen.

29. The method of claim 24 wherein the storage medium playback system comprises a DVD, DVD player and display screen.

30. The method of claim 24 wherein the storage medium playback system comprises computer-accessible web storage and display screen.

31. The method of claim 24 wherein the storage medium playback system comprises a computer with internal storage and playback capability upon a display screen.
Any costs for this amendment, which stresses the electronic storage of the supplemental visual material for selected playback and includes specifically the preferred types of electronic storage medium and playback systems mentioned and contemplated in the specification (CD, DVD, Web, Computer), are to be charged to Deposit Account No. 18-1425 of the undersigned attorney.
